(19) United States
(12) Patent Application Publication
(10) Pub. No.: US 2026/0281646 A1
(43) Pub. Date: Sep. 17, 2026

(54) VEHICLE SOUND CONTROL SYSTEM

(71) Applicant: HONDA MOTOR CO., LTD., Tokyo (JP)

(72) Inventors: Xun WANG, Saitama (JP); Toshio INOUE, Saitama (JP)

(21) Appl. No.: 19/455,962

(22) Filed: Jan. 22, 2026

(30) Foreign Application Priority Data
Mar. 14, 2025 (JP) 2025-040887

(51) Int. Cl. H04S 7/00; H04R 1/02; H04R 1/22

(52) U.S. Cl. CPC H04S 7/30; H04R 1/025; H04R 1/22; H04R 2499/13

(57) ABSTRACT

A vehicle sound control system for a vehicle having at least one seat provided with a headrest, the vehicle sound control system including: at least one reproduction speaker installed in the headrest and configured to reproduce at least one sound source; at least one sound field control speaker installed in the headrest separately from the reproduction speaker; and a controller configured to control the reproduction speaker and the sound field control speaker, and the controller is configured to execute sound field control that forms a plurality of areas having different sound pressure levels by the reproduction speaker and the sound field control speaker.

### TECHNICAL FIELD

The present invention relates to a vehicle sound control system.

### BACKGROUND ART

Conventionally, a vehicle sound control system for controlling sound in a vehicle cabin of a vehicle has been known. For example, JP2010-526484 discloses an audio system for a vehicle in which a directional speaker composed of two speaker units is arranged in a headrest of a vehicle seat.

However, when the directional speaker is used in this manner, directional control (control to make the output sound directional) is always performed on a signal from a sound source. Accordingly, the signal from the sound source may be changed, and the sound source may not be reproduced with high sound quality.

### SUMMARY OF THE INVENTION

In view of the above background, an object of the present invention is to provide a vehicle sound control system that can reproduce a sound source with high sound quality.

To achieve such an object, one aspect of the present invention provides a vehicle sound control system for a vehicle having at least one seat provided with a headrest, the vehicle sound control system comprising: at least one reproduction speaker installed in the headrest and configured to reproduce at least one sound source; at least one sound field control speaker installed in the headrest separately from the reproduction speaker; and a controller configured to control the reproduction speaker and the sound field control speaker, and the controller is configured to execute sound field control that forms a plurality of areas having different sound pressure levels by the reproduction speaker and the sound field control speaker.

Thus, according to the above aspects, it is possible to provide the vehicle sound control system that can reproduce the sound source with high sound quality.

### BRIEF DESCRIPTION OF THE DRAWING(S)

FIG. 1 is a schematic diagram showing an all-seat mode of a sound control system according to a first embodiment of the present invention;

FIG. 2 is a schematic diagram showing an individual-seat mode of the sound control system according to the first embodiment;

FIG. 3 is a front view showing a seat according to the first embodiment;

FIG. 4 is a schematic diagram showing an individual-seat mode of a sound control system according to another embodiment of the present invention;

FIG. 5 is a schematic diagram showing an individual-seat mode of a sound control system according to a second embodiment of the present invention;

FIG. 6 is a schematic diagram showing a sound field control mechanism according to the second embodiment; and

FIG. 7 is a schematic diagram showing an individual-seat mode of a sound control system according to a third embodiment of the present invention.

### DETAILED DESCRIPTION OF THE INVENTION

### First Embodiment

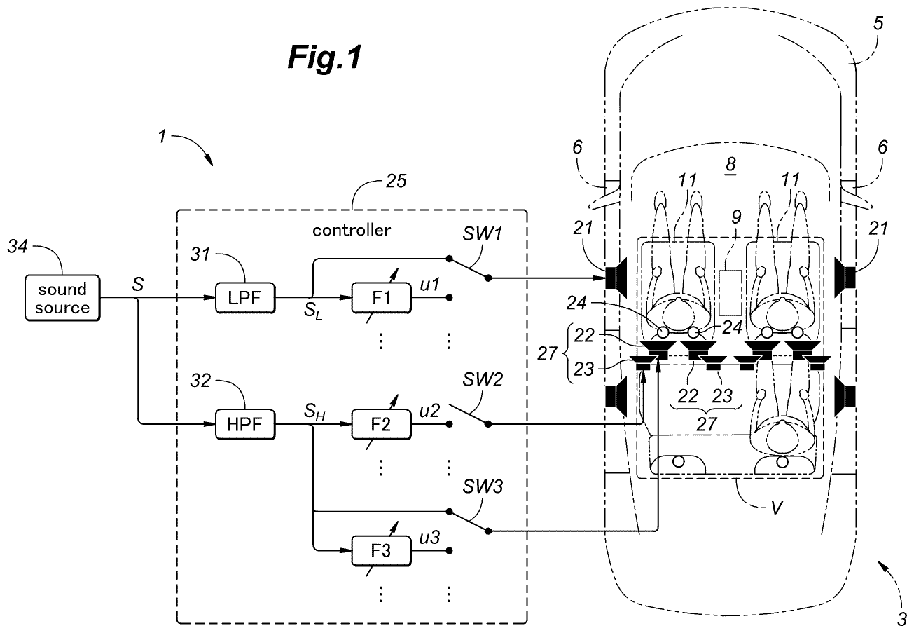

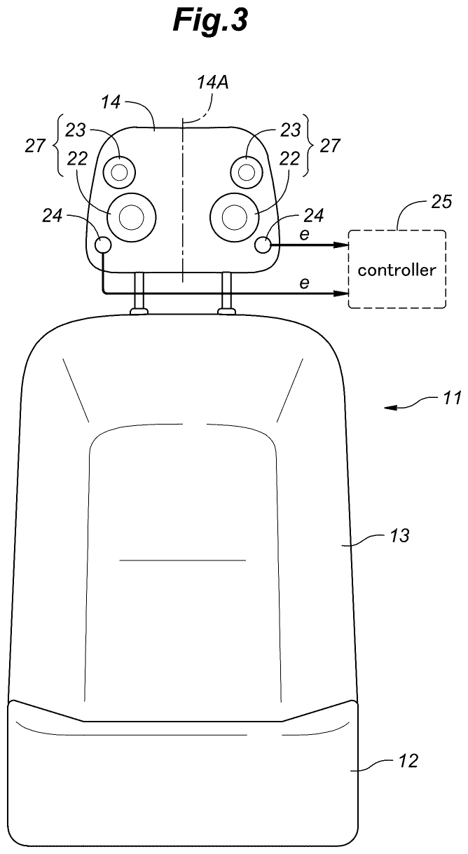

In the following, a vehicle sound control system 1 (hereinafter abbreviated as the “sound control system 1”) according to a first embodiment will be described with reference to FIGS. 1 to 3. Hereinafter, terms indicating directions such as left, right, forward, and rearward are used with reference to a vehicle 3 to which the sound control system 1 is applied.

### <The Vehicle 3>

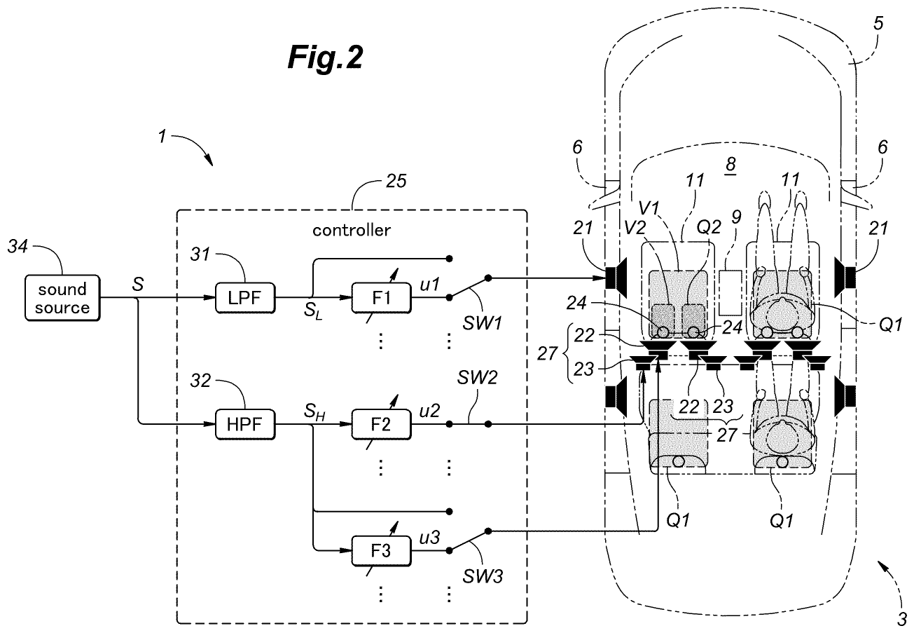

With reference to FIGS. 1 and 2, the vehicle 3 is, for example, a four-wheeled automobile. The vehicle 3 includes a vehicle body 5 that defines the exterior of the vehicle 3, and a plurality of side doors 6 (an example of doors) attached to the left and right sides of the vehicle body 5.

A vehicle cabin 8 is formed inside the vehicle body 5. The vehicle cabin 8 is provided with an operation part 9 (for example, a switch) that accepts operations by an occupant. For example, the operation part 9 is provided on a center console or a steering wheel.

With reference to FIGS. 1 to 3, the vehicle cabin 8 is provided with a plurality of seats 11. Each seat 11 includes a seat cushion 12, a seat back 13 arranged above and behind the seat cushion 12, and a headrest 14 fixed to the upper end of the seat back 13. Hereinafter, the portion of the headrest 14 located on the left side of a lateral center line 14A will be referred to as the “left side portion of the headrest 14,” the portion of the headrest 14 located on the right side of the lateral center line 14A will be referred to as the “right side portion of the headrest 14,” and the left side portion of the headrest 14 and the right side portion of the headrest 14 will collectively be referred to as “the left and right sides of the headrest 14.”

### <The Sound Control System 1>

With reference to FIGS. 1 and 2, the sound control system 1 is a system for controlling sound in the vehicle cabin 8. The sound control system 1 includes a plurality of door speakers 21, a plurality of reproduction speakers 22, a plurality of sound field control speakers 23, a plurality of sound field control microphones 24, and a controller 25.

The plurality of door speakers 21 is provided on the inner surfaces of the plurality of side doors 6, respectively. The door speaker 21 is constituted by a speaker having a lower reproduction frequency band than the reproduction speaker 22 and the sound field control speaker 23.

With reference to FIGS. 1 to 3, a plurality of reproduction speakers 22 are installed on the left and right sides of the headrest 14 of a plurality of seats 11, respectively. The reproduction speaker 22 is constituted by a speaker with higher sound quality than the sound field control speaker 23. For example, the reproduction speaker 22 is constituted by a speaker having a wider reproduction frequency band than the sound field control speaker 23.

The plurality of sound field control speakers 23 are installed in the headrests 14 of the plurality of seats 11 separately from the plurality of reproduction speakers 22. The plurality of sound field control speakers 23 are installed on the left and right sides of the headrests 14 of the plurality of seats 11, respectively. The sound field control speaker 23, together with the reproduction speaker 22, constitutes a directional speaker array 27 (hereinafter abbreviated as the “speaker array 27”).

A plurality of sound field control microphones 24 are installed on the left and right sides of the headrests 14 of the plurality of seats 11, respectively. The sound field control microphone 24 periodically detects the sound pressure at the installation point (hereinafter referred to as the “control point”) and outputs a microphone signal e corresponding to the detected sound pressure to the controller 25.

### <Te Controller 25>

With reference to FIGS. 1 and 2, the controller 25 includes a computer having an arithmetic processing unit (a processor such as a CPU or MPU) and a storage unit (memory such as a ROM or RAM). The controller 25 may be composed of a single piece of hardware, or may be composed of a unit including a plurality of pieces of hardware. The controller 25 controls a plurality of door speakers 21, a plurality of reproduction speakers 22, and a plurality of sound field control speakers 23.

The controller 25 includes a low-pass filter 31 (hereinafter referred to as “LPF 31”), a plurality of first control filters F1, a plurality of first switches SW1, a high-pass filter 32 (hereinafter referred to as “HPF 32”), a plurality of second control filters F2, a plurality of second switches SW2, a plurality of third control filters F3, and a plurality of third switches SW3. In FIGS. 1 and 2, when a plurality of components is provided (for example, a plurality of first control filters F1), only one of the components is shown.

A sound source signal S output from a sound source 34 (for example, an audio sound source) is input to the LPF 31. The LPF 31 extracts a low frequency component SL of the sound source signal S by filtering the sound source signal S. The LPF 31 outputs the low frequency component SL of the sound source signal S to the first control filter F1 and the first switch SW1.

The first control filter F1 is constituted by an adaptively updatable filter based on the Least Mean Square (LMS) algorithm. For example, the first control filter F1 is constituted by a finite impulse response (FIR) filter or a single frequency adaptive notch (SAN) filter. The first control filter F1 generates a first control signal u1 (a signal based on the low frequency component SL of the sound source signal S) by filtering the low frequency component SL of the sound source signal S. The first control filter F1 outputs the first control signal u1 to the first switch SW1.

The first switch SW1 is provided between the LPF 31 and the first control filter F1, and the door speaker 21. The first switch SW1 is switchable between an OFF state (see FIG. 1) in which the low frequency component SL of the sound source signal S from the LPF 31 is output to the door speaker 21, and an ON state (see FIG. 2) in which the first control signal u1 from the first control filter F1 is output to the door speaker 21.

The sound source signal S output from the sound source 34 is input to the HPF 32. The HPF 32 extracts the high frequency component S_{H} of the sound source signal S by filtering the sound source signal S. The HPF 32 outputs the high frequency component S_{H} of the sound source signal S to the second control filter F2, the third control filter F3, and the third switch SW3.

The second control filter F2 is constituted by an adaptively updatable filter based on the LMS algorithm. For example, the second control filter F2 is constituted by the FIR filter or the SAN filter. The second control filter F2 generates a second control signal u2 (a signal based on the high frequency component S_{H} of the sound source signal S) by filtering the high frequency component S_{H} of the sound source signal S. The second control filter F2 outputs the second control signal u2 to the second switch SW2.

The second switch SW2 is provided between the second control filter F2 and the sound field control speaker 23. The second switch SW2 is switchable between the OFF state (see FIG. 1) in which the output of the second control signal u2 from the second control filter F2 to the sound field control speaker 23 is stopped, and the ON state (see FIG. 2) in which the second control signal u2 from the second control filter F2 is output to the sound field control speaker 23.

The third control filter F3 is constituted by an adaptively updatable filter based on the LMS algorithm. For example, the third control filter F3 is constituted by the FIR filter or the SAN filter. The third control filter F3 generates a third control signal u3 (a signal based on the high frequency component S_{H} of the sound source signal S) by filtering the high frequency component S_{H} of the sound source signal S. The third control filter F3 outputs the third control signal u3 to the third switch SW3.

The third switch SW3 is provided between the HPF 32 and the third control filter F3, and the reproduction speaker 22. The third switch SW3 is switchable between the OFF state (see FIG. 1) in which the high frequency component S_{H} of the sound source signal S from the HPF 32 is output to the reproduction speaker 22, and the ON state (see FIG. 2) in which the third control signal u3 from the third control filter F3 is output to the reproduction speaker 22.

### <Mode Switching>

The controller 25 switches between an all-seat mode (an example of a first mode) and an individual-seat mode (an example of a second mode) in response to an operation by the occupant on the operation part 9.

With reference to FIG. 1, in all-seat mode, the controller 25 sets a plurality of first switches SW1 to the OFF state. Accordingly, the low frequency component SL of the sound source signal S is output to the door speakers 21, and the door speakers 21 output sound corresponding to the low frequency component SL of the sound source signal S. That is, the plurality of door speakers 21 reproduces the same sound source 34 as is.

In all-seat mode, the controller 25 sets a plurality of second switches SW2 to the OFF state. This stops the output of the second control signal u2 to the left and right sound field control speakers 23 of each seat 11, and the left and right sound field control speakers 23 of each seat 11 stop outputting sound.

In all-seat mode, the controller 25 sets a plurality of third switches SW3 to the OFF state. Accordingly, the high frequency component S_{H} of the sound source signal S is output to the left and right reproduction speakers 22 of each seat 11, and the left and right reproduction speakers 22 of each seat 11 output sound corresponding to the high frequency component S_{H} of the sound source signal S. That is, the left and right reproduction speakers 22 of each seat 11 reproduce the same sound source 34 as is.

As described above, in all-seat mode, the plurality of door speakers 21 and the left and right reproduction speakers 22 of each seat 11 reproduce the sound source 34 as is. Accordingly, all the seats 11 become an audible area V, and the occupants of all the seats 11 can listen to the sound source 34.

With reference to FIG. 2, in the individual-seat mode, the controller 25 sets the first switch SW1 to the ON state. Accordingly, the first control signal u1 is output to the plurality of door speakers 21, and the plurality of door speakers 21 output sound corresponding to the first control signal u1.

In the individual-seat mode, the controller 25 sets the second switch SW2 to the ON state. Accordingly, the second control signal u2 is output to the left and right sound field control speakers 23 of each seat 11, and the left and right sound field control speakers 23 of each seat 11 output sound corresponding to the second control signal u2.

In the individual-seat mode, the controller 25 sets the third switch SW3 to the ON state. Accordingly, the third control signal u3 is output to the left and right reproduction speakers 22 of each seat 11, and the left and right reproduction speakers 22 of each seat 11 output sound corresponding to the third control signal u3.

As described above, in the individual-seat mode, the plurality of door speakers 21, the left and right sound field control speakers 23 of each seat 11, and the left and right reproduction speakers 22 of each seat 11 output sound corresponding to the first to third control signals u1 to u3, respectively. Accordingly, only some of the seats 11 become audible areas V1 and V2, and only the occupants of some of the seats 11 can listen to the sound source 34. A method for forming the audible areas V1 and V2 in the individual-seat mode will be described in detail below.

### <The First Sound Field Control>

With reference to FIG. 2, in the individual-seat mode, the controller 25 executes the first sound field control by each door speaker 21. In the first sound field control, the controller 25 forms, in the vehicle cabin 8, a plurality of areas V1 and Q1 having different sound pressure levels of the sound source 34. More specifically, the controller 25 forms, in the vehicle cabin 8, the audible area V1 (an example of a first area) and the quiet area Q1 (an example of a second area) having the sound pressure level of the sound source 34 lower than that of the audible area V1. The first sound field control will be described in detail below.

The controller 25 sets the sound pressure of the microphone signal e from the sound field control microphone 24 provided at the seat 11 in the audible area V1 to a sound pressure p_{Vm} in the audible area V1, and sets the sound pressure of the microphone signal e from the sound field control microphone 24 provided at the seat 11 in the quiet area Q1 to a sound pressure pom in the quiet area Q1. For example, if the seat 11 in the audible area V1 is the driver's seat, the controller 25 sets the sound pressure of the microphone signal e from the sound field control microphone 24 provided at the driver's seat to the sound pressure p_{Vm} in the audible area V1, and sets the sound pressure of the microphone signal e from the sound field control microphone 24 provided at the other seat 11 to the sound pressure pom in the quiet area Q1.

Here, an evaluation function J of the LMS algorithm is expressed by the following formula (1).

$$J = {e}^{2} = {( \frac{1}{{M}_{V}} {\sum }_{m = 1}^{{M}_{V}} {p}_{Vm}^{2} - \frac{1}{{M}_{Q}} {\sum }_{m = 1}^{{M}_{Q}} {p}_{Qm}^{2} - D )}^{2} \qquad ( 1 )$$

The first term (1/M_{V} . . . ) and the second term (1/M_{Q} . . . ) on the right-hand side of the above formula (1) represent an average value of the acoustic energy in the audible area V1 and an average value of the acoustic energy in the quiet area Q1, respectively. M_{V} and M_{Q} in the above formula (1) indicate the number of sound field control microphones 24 in the audible area V1 and the number of sound field control microphones 24 in the quiet area Q1, respectively. D in the above formula (1) represents the target value of the difference in the acoustic energy between the audible area V1 and the quiet area Q1.

The controller 25 adaptively updates the first control filter F1 based on the LMS algorithm so that the difference in the acoustic energy between the audible area V1 and the quiet area Q1 is equal to or greater than a certain level. More specifically, the controller 25 adaptively updates the first control filter F1 according to the following formula (2) so that the evaluation function J of the LMS algorithm is minimized. In the present embodiment, the controller 25 utilizes a digital signal processor (DSP) to adaptively update the first control filter F1 in real time.

$$F {1}_{n} ( t + 1 ) = F {1}_{n} ( t ) - μ e ( t ) ( \frac{1}{{M}_{V}} {\sum }_{m = 1}^{{M}_{V}} {p}_{Vm} ( t ) \times S ( t ) * {G}_{n , Vm} ( t ) - \frac{1}{{M}_{Q}} {\sum }_{m = 1}^{{M}_{Q}} {p}_{Qm} ( t ) \times S ( t ) * {G}_{n , Qm} ( t ) ) \qquad ( 2 )$$

In the above formula (2), n represents the number of door speakers 21. In the above formula (2), t represents discrete time. In the above formula (2), u represents a step size parameter. The “*” in the above formula (2) indicates a convolution operation. Gₙ, vₘ in the above formula (2) represents the acoustic characteristics from the nth door speaker 21 to the mth sound field control microphone 24 in the audible area V1. G_{n,Qm} in the above formula (2) represents the acoustic characteristics from the nth door speaker 21 to the mth sound field control microphone 24 in the quiet area Q1. G_{n,Vm} and G_{n,Qm} in the above formula (2) are values measured in advance.

The controller 25 generates the first control signal u1 by filtering the low frequency component SL of the sound source signal S using the adaptively updated first control filter F1. The controller 25 outputs the first control signal u1 to each door speaker 21. In response, each door speaker 21 outputs sound corresponding to the first control signal u1. Accordingly, the audible area V1 and the quiet area Q1 are formed in the vehicle cabin 8.

### <Second Sound Field Control>

With reference to FIG. 2, in the individual-seat mode, the controller 25 executes the second sound field control by each speaker array 27 (i.e., the reproduction speaker 22 and the sound field control speaker 23). In the second sound field control, the controller 25 forms, in the vehicle cabin 8, a plurality of areas V2 and Q2 having different sound pressure levels of the sound source 34. More specifically, in the second sound field control, the controller 25 forms, in the vehicle cabin 8, the audible area V2 (an example of a first area) and the quiet area Q2 (an example of a second area) having the sound pressure level of the sound source 34 lower than that of the audible area V2. The second sound field control will be described in detail below.

The controller 25 sets the sound pressure of the microphone signal e from either of the left or right sound field control microphones 24 provided at a certain seat 11 (the sound field control microphone 24 closer to the speaker array 27 to be controlled) to the sound pressure p_{Vm} in the audible area V2, and sets the sound pressure of the microphone signal e from the other of the left and right sound field control microphone 24 provided at that seat 11 (the sound field control microphone 24 farther from the speaker array 27 to be controlled) to the sound pressure pom in the quiet area Q2. For example, the controller 25 sets the sound pressure of the microphone signal e from either of the left or right sound field control microphone 24 provided at the driver's seat to the sound pressure p_{Vm} in the audible area V2, and sets the sound pressure of the microphone signal e from the other of the left and right sound field control microphone 24 provided at the driver' seat to the sound pressure pom in the quiet area Q2.

The controller 25 adaptively updates the second control filter F2 and the third control filter F3 based on the LMS algorithm so that the difference in the acoustic energy between the audible area V2 and the quiet area Q2 is equal to or greater than a certain level. The adaptive updating of the second control filter F2 and the third control filter F3 is similar to the adaptive updating of the first control filter F1, and therefore, a description thereof will be omitted.

The controller 25 generates the second control signal u2 by filtering the high frequency component S_{H} of the sound source signal S using the adaptively updated second control filter F2. The controller 25 outputs the second control signal u2 to the left and right sound field control speakers 23 of each seat 11. In response, the left and right sound field control speakers 23 of each seat 11 output sound corresponding to the second control signal u2.

The controller 25 generates the third control signal u3 by filtering the high frequency component S_{H} of the sound source signal S using the adaptively updated third control filter F3. The controller 25 outputs the third control signal u3 to the left and right reproduction speakers 22 of each seat 11. In response, the left and right reproduction speakers 22 of each seat 11 output sound corresponding to the third control signal u3.

As described above, the left and right speaker arrays 27 of each seat 11 output sound corresponding to the second and third control signals u2 and u3, respectively. Accordingly, the audible area V2 and the quiet area Q2 are formed in the vehicle cabin 8. The audible area V2 in the second sound field control is narrower than the audible area V1 in the first sound field control.

### <Effects>

In the all-seat mode, the controller 25 stops the sound field control when causing the reproduction speakers 22 of the plurality of seats 11 to reproduce the same sound source 34. Accordingly, it is possible to suppress the deterioration in sound quality caused by the signal processing for the sound field control, and to reproduce the sound source 34 with high sound quality. On the other hand, in the individual-seat mode, the controller 25 controls the sound directionality (the reproduction range of the sound source 34) in the vehicle cabin 8 by executing the first sound field control and the second sound field control. Accordingly, it is possible to separate the sound field in the vehicle cabin 8 and to realize reproduction of the sound source 34 for each seat 11.

Since the sound field control speaker 23 is a speaker for the sound field control, it is not necessary for the sound field control speaker 23 to reproduce the sound source 34 with high sound quality like the reproduction speaker 22. Accordingly, an inexpensive speaker with lower sound quality than the reproduction speaker 22 can be used as the sound field control speaker 23. That is, the speaker array 27 can be configured by combining the expensive reproduction speaker 22 and the inexpensive sound field control speaker 23. This allows the sound control system 1 to be manufactured at a lower cost as compared with a case where the speaker array 27 is configured by combining two expensive reproduction speakers 22. Therefore, both sound quality assurance and the sound field separation can be achieved at low cost.

In the first sound field control, the controller 25 forms the audible area V1 using all the door speakers 21 installed over a wide area in the vehicle cabin 8. Accordingly, a wide audible area V1 can be formed for each seat 11.

In the second sound field control, the controller 25 sets the sound pressure of the microphone signal e from either of the left or right sound field control microphone 24 provided at a certain seat 11 to the sound pressure p_{Vm} in the audible area V2, and sets the sound pressure of the microphone signal e from the other of the left and right sound field control microphone 24 provided at the seat 11 to the sound pressure pom in the quiet area Q2. Accordingly, it is possible to limit the audible area V2 to the vicinity of one ear of the occupant, and to limit the reproduction range of the sound source 34 to a minimum necessary. Accordingly, the effect of separating the sound field in the vehicle cabin 8 can be further improved. Further, since the second sound field control is performed using only the sound pressures of the microphone signals e from two sound field control microphones 24 provided at a certain seat 11, the number of control points can be reduced as compared with a case where the second sound field control is performed using the sound pressures of the microphone signals e from the sound field control microphones 24 provided at all the seats 11. This reduces the amount of calculation required for adaptively updating the second and third control filters F2 and F3, making it easier to execute the adaptive updating of the second and third control filters F2 and F3 in real time. Accordingly, it is possible to adaptively learn changes in the sound field in the vehicle cabin 8, and to improve the effectiveness of sound control.

### MODIFIED EMBODIMENT

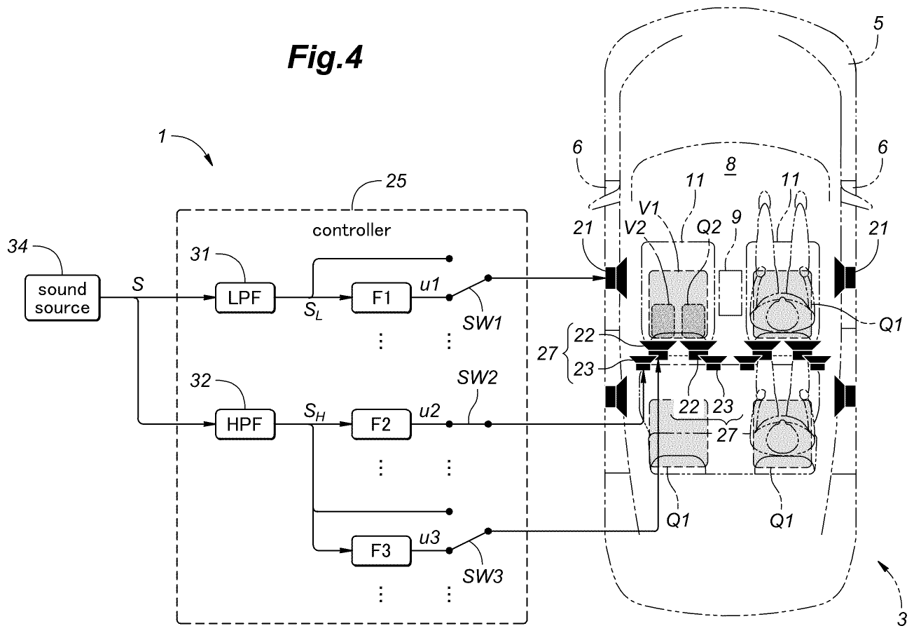

In the above embodiment, the sound control system 1 includes the plurality of sound field control microphones 24. With reference to FIG. 4, according to another embodiment, the sound control system 1 does not necessarily include the sound field control microphone 24. In this case, the controller 25 may create the first to third control filters F1 to F3 offline before executing the sound field control, and use the first to third control filters F1 to F3 as fixed filters in the sound field control.

In the above embodiment, in the second sound field control, the controller 25 sets the sound pressure of the microphone signal e from either of the left or right sound field control microphone 24 provided at a certain seat 11 to the sound pressure p_{Vm} in the audible area V2, and sets the sound pressure of the microphone signal e from the other of the left and right sound field control microphone 24 provided at the seat 11 to the sound pressure pom in the quiet area Q2. In another embodiment, in the second sound field control, the controller 25 may set the sound pressure of the microphone signal e from either of the left or right sound field control microphone 24 provided at a certain seat 11 to the sound pressure p_{Vm} in the audible area V2, and set the sound pressure of the microphone signals e from the other sound field control microphones 24 to the sound pressure pom in the quiet area Q2. For example, the controller 25 may set the sound pressure of the microphone signal e from either of the left or right sound field control microphone 24 provided at the driver's seat to the sound pressure p_{Vm} in the audible area V2, and set the sound pressure of the microphone signals e from all of the other sound field control microphones 24 to the sound pressure pom in the quiet area Q2. This increases the amount of calculation required for adaptively updating the second and third control filters F2 and F3 compared to the above embodiment, but can improve the effect of acoustic control.

In the above embodiment, the audio sound source is used as an example of the sound source 34. In another embodiment, sources other than the audio sound source may be used as an example of the sound source 34. For example, according to another embodiment, the voice of a person on the other end of a call during execution of a hands-free telephone (HFT) may be used as an example of the sound source 34. In this case, when a private call mode of the HFT is turned ON in response to the operation on the operation part 9 by the occupant, the controller 25 may switch the all-seat mode to the individual-seat mode.

### Second Embodiment

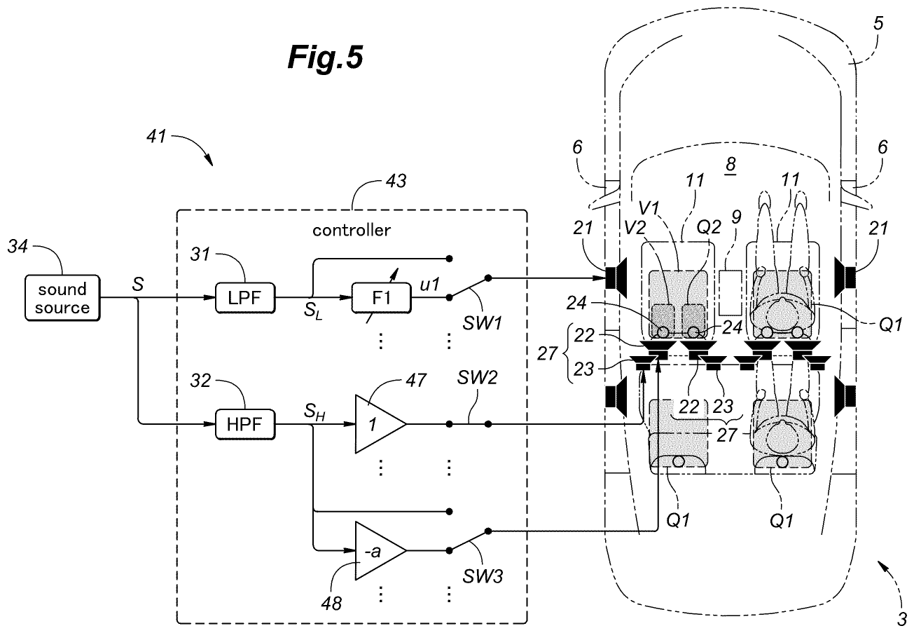

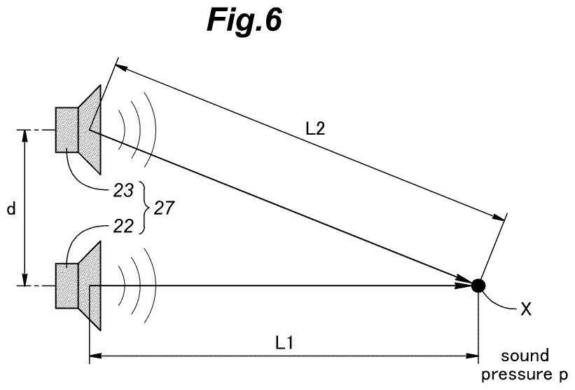

In the following, with reference to FIGS. 5 and 6, a vehicle sound control system 41 (hereinafter abbreviated as the “sound control system 41”) according to the second embodiment will be described. The components of the sound control system 41 other than a controller 43 are the same as those of the sound control system 1 according to the first embodiment, and therefore the description thereof will be omitted. As for the controller 43, the description duplicated with the first embodiment will be omitted.

### <The Controller 43>

With reference to FIG. 5, the controller 43 includes the LPF 31, the plurality of first control filters F1, the plurality of first switches SW1, the HPF 32, a plurality of first filters 47, the plurality of second switches SW2, a plurality of second filters 48, and the plurality of third switches SW3. In FIG. 5, when a plurality of components is provided (for example, the plurality of first control filters F1), only one of the components is shown. The components of the controller 43 other than the plurality of first filters 47 and the plurality of second filters 48 are the same as those of the controller 25 according to the first embodiment, and therefore, a description thereof will be omitted.

The high frequency component S_{H} of the sound source signal S output from the HPF 32 is input to the first filter 47. The first filter 47 outputs the high frequency component S_{H} of the sound source signal S to the second switch SW2 without modification.

The high frequency component S_{H} of the sound source signal S output from the HPF 32 is input to the second filter 48. The second filter 48 multiplies the high frequency component S_{H} of the sound source signal S by a coefficient a, and then inverts the phase of the high frequency component S_{H} of the sound source signal S. The coefficient a is the coefficient for correcting the difference in characteristics between the reproduction speaker 22 and the sound field control speaker 23. The second filter 48 outputs the phase-inverted high frequency component S_{H} of the sound source signal S to the third switch SW3.

The controller 43 switches between the all-seat mode (an example of the first mode) and the individual-seat mode (an example of the second mode) by switching the states of the first to third switches SW1 to SW3. In the individual-seat mode, the controller 43 executes the first sound field control by each door speaker 21 and the second sound field control by each speaker array 27 (i.e., the reproduction speaker 22 and the sound field control speaker 23). The description of the first sound field control is omitted here.

### <The Second Sound Field Control>

In the second sound field control, the controller 43 forms, in the vehicle cabin 8, a plurality of areas V2 and Q2 having different sound pressure levels of the sound source 34. More specifically, in the second sound field control, the controller 43 forms, in the vehicle cabin 8, the audible area V2 (an example of the first area) and the quiet area Q2 (an example of the second area) having the sound pressure level of the sound source 34 lower than that of the audible area V2. The second sound field control will be described in detail below.

In the second sound field control, the controller 43 sets the second switch SW2 to the ON state. Accordingly, the high frequency component S_{H} of the sound source signal S is output to the left and right sound field control speakers 23 of each seat 11, and the left and right sound field control speakers 23 of each seat 11 output sound corresponding to the high frequency component S_{H} of the sound source signal S.

In the second sound field control, the controller 43 sets the third switch SW3 to the ON state. Accordingly, the phase-inverted high frequency component S_{H} of the sound source signal S is output to the left and right reproduction speakers 22 of each seat 11, and the left and right reproduction speakers 22 of each seat 11 output sounds that are in opposite phase to the sounds output from the left and right sound field control speakers 23 of each seat 11. In other words, the left and right sound field control speakers 23 of each seat 11 output sounds that are in opposite phase to the sounds output from the left and right reproduction speakers 22 of each seat 11.

Here, the sound transmission in the free sound field is expressed by the following formula (3).

$$p = \frac{1}{L} {e}^{j ω \frac{L}{C}} \qquad ( 3 )$$

In the above formula (3), p represents the sound pressure at a point in the free sound field. In the above formula (3), 1/L and e^{jωL/c} represent the attenuation due to distance and the phase change due to distance, respectively. In the above formula (3), e and j represent the exponential and imaginary unit, respectively. In the above formula (3), ω, C, and L/C represent the angular frequency, the sound speed, and the propagation time, respectively.

From the above formula (3), a sound pressure p at a point X in the vehicle cabin 8 is expressed by the following formula (4).

$$p = \frac{1}{L 1} {e}^{j ω \frac{L 1}{C}} - \frac{a}{L 2} {e}^{j ω \frac{L 2}{C}} \qquad ( 4 )$$

With reference to FIGS. 6, L1 and L2 in the above formula (4) represent the distance from the reproduction speaker 22 to point X and the distance from the sound field control speaker 23 to point X, respectively. The first and second terms on the right-hand side of the above formula (4) represent the sound pressure of the sound output by the reproduction speaker 22 and the sound pressure of the sound output by the sound field control speaker 23, respectively. L2 in the above formula (4) is expressed by the following formula (5).

$$L 2 = \sqrt{L {1}^{2} + {d}^{2}} \qquad ( 5 )$$

In the above formula (5), d represents the distance between the reproduction speaker 22 and the sound field control speaker 23.

As is clear from the above formula (5), if L1 and L2 are sufficiently long compared with d, L1≈L2 holds. Here, the coefficient a in the above formula (4) is set so that the first and second terms on the right-hand side of the above formula (4) are equal when L1=L2. Accordingly, when L1 and L2 are sufficiently long compared with d (when L1≈L2), the first and second terms on the right-hand side of the above formula (4) become approximately equal, and the sound pressure p at point X becomes significantly reduced. In other words, at a location far from a certain speaker array 27, since the sound output by the reproduction speaker 22 and the sound output by the sound field control speaker 23 cancel each other out, the sound output from the speaker array 27 becomes substantially inaudible.

On the other hand, if L1 and L2 are not sufficiently long compared with d, the difference between L1 and L2 becomes large. Accordingly, the difference between the first and second terms on the right-hand side of the above formula (4) becomes large, and the sound pressure p at point X increases. In other words, the sound output from a certain speaker array 27 becomes substantially more audible in a location closer to the speaker array 27.

Accordingly, the sound pressure level of the sound source 34 becomes higher in a location closer to a certain speaker array 27 (for example, a location of the seat 11 closer to that speaker array 27) than in a location farther from the speaker array 27 (for example, a location of the seat 11 farther from that speaker array 27). Accordingly, a location close to a certain speaker array 27 can be set as the audible area V2, and a location far from the speaker array 27 can be set as the quiet area Q2.

### <Effects>

In the second sound field control, the controller 43 controls the directionality of sound in the vehicle cabin 8 (the reproduction range of the sound source 34) by causing the left and right sound field control speakers 23 to output sounds that are in opposite phase to the sounds output from the left and right reproduction speakers 22. Accordingly, it is possible to suppress the complexity of the second sound field control as compared with the first embodiment, and to realize the second sound field control with a small amount of calculation.

### Third Embodiment

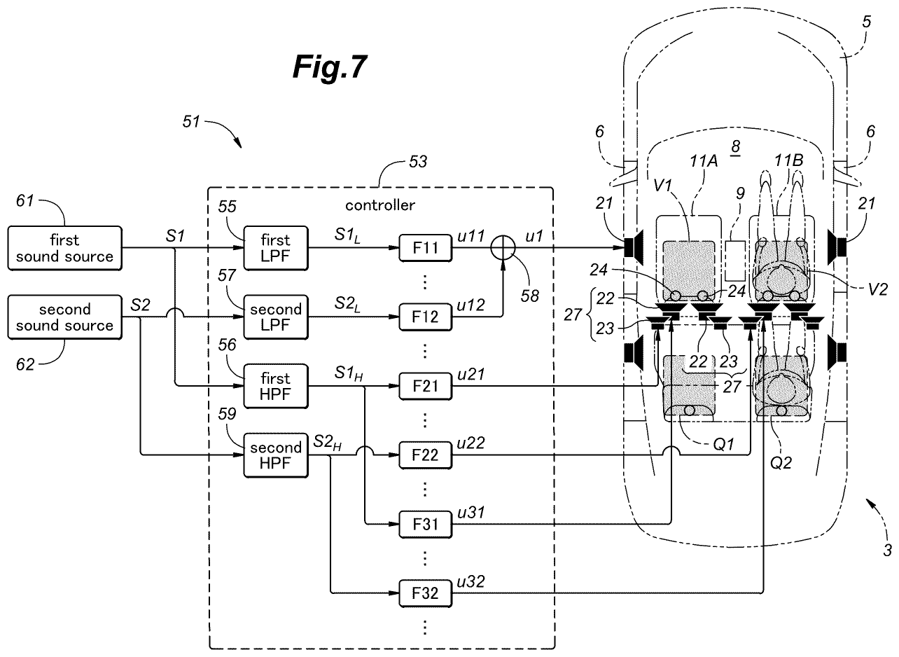

In the following, with reference to FIG. 7, a vehicle sound control system 51 (hereinafter abbreviated as the “sound control system 51”) according to the third embodiment will be described. The components of the sound control system 51 other than a controller 53 are the same as those of the sound control system 1 according to the first embodiment, and therefore, the description thereof will be omitted. As for the controller 53, the description duplicated with the first embodiment will be omitted.

The controller 53 includes a first low-pass filter 55 (hereinafter referred to as the “first LPF 55”), a plurality of first control filters F11, a first high-pass filter 56 (hereinafter referred to as the “first HPF 56”), a plurality of second control filters F21, a plurality of third control filters F31, a second low-pass filter 57 (hereinafter referred to as the “second LPF 57”), a plurality of first control filters F12, a plurality of adders 58, a second high-pass filter 59 (hereinafter referred to as the “second HPF 59”), a plurality of second control filters F22, and a plurality of third control filters F32. In FIG. 7, when a plurality of components is provided (for example, the plurality of first control filters F11), only one of the components is shown.

A first sound source signal S1 is input to the first LPF 55 from a first sound source 61 (for example, an audio sound source). The first LPF 55 extracts a low frequency component SIL of the first sound source signal S1 by filtering the first sound source signal S1. The first LPF 55 outputs the low frequency component SIL of the first sound source signal S1 to the first control filter F11.

The first control filter F11 is a control filter for delivering the first sound source signal S1 only to the audible area V1 of a certain seat 11 (hereinafter referred to as a “first seat 11A”). The first control filter F11 generates a first control signal u11 by filtering the low frequency component SIL of the first sound source signal S1. The first control filter F11 outputs the first control signal u11 to the adder 58.

The first sound source signal S1 is input to the first HPF 56 from the first sound source 61. The first HPF 56 extracts a high frequency component S1_{H} of the first sound source signal S1 by filtering the first sound source signal S1. The first HPF 56 outputs the high frequency component S1_{H} of the first sound source signal S1 to the second control filter F21 and the third control filter F31.

The second control filter F21 is a control filter for delivering the first sound source signal S1 only to the audible area V1 of the first seat 11A. The second control filter F21 generates a second control signal u21 by filtering the high frequency component S1_{H} of the first sound source signal S1.

The third control filter F31 is a control filter for delivering the first sound source signal S1 only to the audible area V1 of the first seat 11A. The third control filter F31 generates a third control signal u31 by filtering the high frequency component S1_{H} of the first sound source signal S1.

A second sound source signal S2 is input to the second LPF 57 from a second sound source 62 (for example, an audio sound source). The second LPF 57 extracts a low frequency component S2_{L} of the second sound source signal S2 by filtering the second sound source signal S2. The second LPF 57 outputs the low frequency component S2_{L} of the second sound source signal S2 to the first control filter F12.

The first control filter F12 is a control filter for delivering the second sound source signal S2 only to the audible area V2 of the seat 11 (hereinafter referred to as a “second seat 11B”) that is different from the first seat 11A. The first control filter F12 generates a first control signal u12 by filtering the low frequency component S2_{L} of the second sound source signal S2. The first control filter F12 outputs the first control signal u12 to the adder 58.

The adder 58 generates the first control signal u1 by adding the first control signal u11 from the first control filter F11 and the first control signal u12 from the first control filter F12. The adder 58 outputs the first control signal u1 to each door speaker 21. This causes each door speaker 21 to output sound corresponding to the first control signal u1.

The second sound source signal S2 is input to the second HPF 59 from the second sound source 62. The second HPF 59 extracts a high frequency component S2_{H} of the second sound source signal S2 by filtering the second sound source signal S2. The second HPF 59 outputs the high frequency component S2_{H} of the second sound source signal S2 to the second control filter F22 and the third control filter F32.

The second control filter F22 is a control filter for delivering the second sound source signal S2 only to the audible area V2 of the second seat 11B. The second control filter F22 generates a second control signal u22 by filtering the high frequency component S2_{H} of the second sound source signal S2.

The third control filter F32 is a control filter for delivering the second sound source signal S2 only to the audible area V2 of the second seat 11B. The third control filter F32 generates a third control signal u32 by filtering the high frequency component S2_{H} of the second sound source signal S2.

The controller 53 switches between the all-seat mode (an example of the first mode) and the individual-seat mode (an example of the second mode) by switching the states of a plurality of switches (not shown). In the individual-seat mode, the controller 53 executes the first sound field control by each door speaker 21 and the second sound field control by each speaker array 27 (i.e., the reproduction speaker 22 and the sound field control speaker 23). The description of the first sound field control is omitted here.

### <The Second Sound Field Control>

In the second sound field control, the controller 53 forms, in the vehicle cabin 8, a plurality of areas V1, V2, Q1, and Q2 having a different sound pressure level of the first and second sound sources 61 and 62. More specifically, the controller 53 forms, in the vehicle cabin 8, the first and second audible areas V1 and V2, and the quiet areas Q1 and Q2 having the sound pressure levels of the first and second sound sources 61 and 62 lower than those of the first and second audible areas V1 and V2. The second sound field control will be described in detail below.

In the second sound field control, the controller 53 outputs the second control signal u21 from the second control filter F21 to the left and right sound field control speakers 23 of the first seat 11A. Accordingly, the left and right sound field control speakers 23 of the first seat 11A output sound corresponding to the second control signal u21. In the second sound field control, the controller 53 outputs the third control signal u31 from the third control filter F31 to the left and right reproduction speakers 22 of the first seat 11A. Accordingly, the left and right reproduction speakers 22 of the first seat 11A output sound corresponding to the third control signal u31. As described above, the left and right speaker arrays 27 of the first seat 11A output sound corresponding to the second and third control signals u21 and u31, thereby forming the audible area V1 at the first seat 11A, and the first sound source 61 is reproduced in the audible area V1. At this time, the left and right speaker arrays 27 of the first seat 11A output the same sound.

In the second sound field control, the controller 53 outputs the second control signal u22 from the second control filter F22 to the left and right sound field control speakers 23 of the second seat 11B. Accordingly, the left and right sound field control speakers 23 of the second seat 11B output sound corresponding to the second control signal u22. In the second sound field control, the controller 53 outputs the third control signal u32 from the third control filter F32 to the left and right reproduction speakers 22 of the second seat 11B. Accordingly, the left and right reproduction speakers 22 of the second seat 11B output sound corresponding to the third control signal u32. As described above, the left and right speaker arrays 27 of the second seat 11B output sound corresponding to the second and third control signals u22 and u32, thereby forming the audible area V2 in the second seat 11B, and the second sound source 62 is reproduced in the audible area V2. At this time, the left and right speaker arrays 27 of the second seat 11B output the same sound.

### <Effects>

The speaker array 27 reproduces different sound sources 61 and 62 for the seats 11A and 11B, respectively, and the controller 53 performs the second sound field control for each of the seats 11A and 11B. Accordingly, areas for listening to the different sound sources 61 and 62 can be formed for each of the seats 11A and 11B. Therefore, the occupant can listen to the sound source 61 or 62 that suits the preference of the occupant without being affected by the sound sources 61 and 62 listened to by other occupants.

### Modified Embodiment

In the above embodiment, two sound sources 61 and 62 corresponding to two seats 11A and 11B are used. In another embodiment, three or more sound sources corresponding to three or more seats may be used.

This concludes the explanation of the specific embodiment, but the present invention is not limited to the above embodiment or modified embodiment, and can be widely modified and implemented.

### Summary of Embodiments

A vehicle sound control system 1, 41, 51 for a vehicle 3 having at least one seat 11 provided with a headrest 14, the vehicle sound control system comprising: at least one reproduction speaker 22 installed in the headrest 14 and configured to reproduce at least one sound source 34, 61, 62; at least one sound field control speaker 23 installed in the headrest 14 separately from the reproduction speaker 22; and a controller 25, 43, 53 configured to control the reproduction speaker 22 and the sound field control speaker 23, and the controller 25, 43, 53 is configured to execute sound field control that forms a plurality of areas V1, V2, Q1, and Q2 having different sound pressure levels by the reproduction speaker 22 and the sound field control speaker 23.

According to this aspect, when the sound field control is not executed, the reproduction speaker 22 can reproduce the sound sources 34, 61, and 62 as is. Accordingly, it is possible to suppress the deterioration in sound quality caused by the signal processing for the sound field control, and to reproduce the sound sources 34, 61, and 62 with high sound quality. On the other hand, when the sound field control is executed, the sound directionality (the reproduction range of the sound sources 34, 61, 62) in the vehicle cabin 8 can be controlled. Accordingly, it is possible to separate the sound field in the vehicle cabin 8 and to realize reproduction of the sound sources 34, 61, and 62 for each seat 11. As described above, both sound quality and the sound field separation can be achieved.

The at least one sound field control speaker 23 comprises a plurality of sound field control speakers 23, and the sound field control speakers 23 are installed on left and right sides of the headrest 14.

According to this aspect, the sound field control speakers 23 are arranged at positions corresponding to the left and right ears of the occupant. This enhances the effect of separating the sound fields in the vehicle cabin 8 by the sound field control.

The vehicle sound control system 1 further includes sound field control microphones 24 installed on the left and right sides of the headrest 14, and the controller 25, in the sound field control, is configured to control the left and right sound field control speakers 23 based on signals from the left and right sound field control microphones 24.

According to this aspect, it is possible to periodically detect the sound pressure at the control point by the sound field control microphone 24, and to execute the sound field control based on the detected sound pressure at the control point. This enhances the effect of separating the sound fields in the vehicle cabin 8 by the sound field control.

The at least one reproduction speaker 22 comprises a plurality of reproduction speakers 22, the at least one sound field control speaker 23 comprises a plurality of sound field control speakers 23, the reproduction speakers 22 and the sound field control speakers 23 are respectively installed on left and right sides of the headrest 14, and the controller 43, in the sound field control, is configured to cause the left and right sound field control speakers 23 to output sound that is in opposite phase to sound output from the left and right reproduction speakers 22.

According to this aspect, it is possible to suppress the complexity of the sound field control and to realize the sound field control with a small amount of calculation.

The at least one seat 11 comprises a plurality of seats 11, the at least one sound source 61, 62 comprises a plurality of sound sources 61, 62, the reproduction speaker 22 and the sound field control speaker 23 are provided in each of the plurality of seats 11 and configured to reproduce the different sound sources 61 and 62 for each of the plurality of seats 11, and the controller 53 is configured to execute the sound field control for each of the plurality of seats 11.

According to this aspect, when the different sound sources 61 and 62 are reproduced for each seat 11, the sound field control is executed for each seat 11, whereby, for each seat 11, an area for listening to the different sound sources 61 and 62 can be formed. Therefore, the occupant can listen to the sound source 61 or 62 that suits the preference of the occupant without being affected by the sound sources 61 and 62 listened to by other occupants.

The at least one seat 11 comprises a plurality of seats 11, the reproduction speaker 22 is provided in each of the plurality of seats 11, and the controller 25 is configured to stop the sound field control when causing the reproduction speaker 22 of each of the plurality of seats 11 to reproduce the same sound source 34.

According to this aspect, when the controller 25 causes the reproduction speakers 22 of a plurality of seats 11 to reproduce the same sound source 34, the signal processing for the sound field control is not performed, so that the amount of calculation of the controller 25 can be reduced. Further, it is possible to suppress the deterioration in sound quality caused by the signal processing for the sound field control and to reproduce the sound source 34 with high sound quality.

The vehicle sound control system 1 further comprising a door speaker 21 provided on a door 6 of the vehicle 3, and the controller 25 includes a low-pass filter 31 configured to extract a low frequency component SL of a sound source signal S output from the sound source 34, and a high-pass filter 32 configured to extract a high frequency component S_{H} of the sound source signal S, the controller is configured to: output the low frequency component SL of the sound source signal S or a signal u1 based thereon to the door speaker 21; and output the high frequency S_{H} component of the sound source signal S or a signal u2, u3 based thereon to the reproduction speaker 22 and the sound field control speaker 23.

According to this aspect, signals suited to the respective frequency characteristics of the door speaker 21, the reproduction speaker 22, and the sound field control speaker 23 can be output. Accordingly, it is possible to reproduce the sound source 34 with even higher sound quality.

The controller 25 is configured to switch a first mode in which the sound source 34 is reproduced by the reproduction speaker 22 with the sound field control stopped, and a second mode in which the sound field control is executed by the reproduction speaker 22 and the sound field control speaker 23.

According to this aspect, by switching between a first mode in which the sound field control is stopped and a second mode in which the sound field control is executed, it is possible to realize the sound quality assurance in the first mode and the sound field separation in the second mode.

The vehicle sound control system 1 further comprises a door speaker 21 provided on a door 6 of the vehicle 3, and the controller 25, in the second mode, is capable of executing the sound field control by the reproduction speaker 22 and the sound field control speaker 23, and the sound field control by the door speaker 21.

According to this aspect, in addition to the sound field control by the reproduction speaker 22 and the sound field control speaker 23, the effect of separating the sound fields in the vehicle cabin 8 by the sound field control can be enhanced by executing the sound field control by the door speaker 21.

1. A vehicle sound control system for a vehicle having at least one seat provided with a headrest, the vehicle sound control system comprising:
at least one reproduction speaker installed in the headrest and configured to reproduce at least one sound source;
at least one sound field control speaker installed in the headrest separately from the reproduction speaker; and
a controller configured to control the reproduction speaker and the sound field control speaker, wherein
the controller is configured to execute sound field control that forms a plurality of areas having different sound pressure levels by the reproduction speaker and the sound field control speaker.

2. The vehicle sound control system according to claim 1, wherein the at least one sound field control speaker comprises a plurality of sound field control speakers, and
the sound field control speakers are installed on left and right sides of the headrest.

3. The vehicle sound control system according to claim 2, further comprising sound field control microphones installed on the left and right sides of the headrest, wherein
the controller, in the sound field control, is configured to control the left and right sound field control speakers based on signals from the left and right sound field control microphones.

4. The vehicle sound control system according to claim 1, wherein the at least one reproduction speaker comprises a plurality of reproduction speakers,
the at least one sound field control speaker comprises a plurality of sound field control speakers,
the reproduction speakers and the sound field control speakers are respectively installed on left and right sides of the headrest, and
the controller, in the sound field control, is configured to cause the left and right sound field control speakers to output sound that is in opposite phase to sound output from the left and right reproduction speakers.

5. The vehicle sound control system according to claim 1, wherein the at least one seat comprises a plurality of seats,
the at least one sound source comprises a plurality of sound sources,
the reproduction speaker and the sound field control speaker are provided in each of the plurality of seats and configured to reproduce the different sound sources for each of the plurality of seats, and
the controller is configured to execute the sound field control for each of the plurality of seats.

6. The vehicle sound control system according to claim 1, wherein the at least one seat comprises a plurality of seats,
the reproduction speaker is provided in each of the plurality of seats, and
the controller is configured to stop the sound field control when causing the reproduction speaker of each of the plurality of seats to reproduce the same sound source.

7. The vehicle sound control system according to claim 1, further comprising a door speaker provided on a door of the vehicle, wherein
the controller includes a low-pass filter configured to extract a low frequency component of a sound source signal output from the sound source, and a high-pass filter configured to extract a high frequency component of the sound source signal,
the controller is configured to:
output the low frequency component of the sound source signal or a signal based thereon to the door speaker; and
output the high frequency component of the sound source signal or a signal based thereon to the reproduction speaker and the sound field control speaker.

8. The vehicle sound control system according to claim 1, wherein
the controller is configured to switch
a first mode in which the sound source is reproduced by the reproduction speaker with the sound field control stopped, and
a second mode in which the sound field control is executed by the reproduction speaker and the sound field control speaker.

9. The vehicle sound control system according to claim 8, further comprising a door speaker provided on a door of the vehicle, wherein
the controller, in the second mode, is capable of executing the sound field control by the reproduction speaker and the sound field control speaker, and the sound field control by the door speaker.
